(19) United States
(12) Patent Application Publication
(10) Pub. No.: US 2024/0080656 A1
(43) Pub. Date: Mar. 7, 2024

(54) METHODS AND SYSTEMS FOR TRANSFERRING USER EQUIPMENT CAPABILITY INFORMATION

(71) Applicant: ZTE Corporation, Shenzhen (CN)

(72) Inventors: Wei MA, Shenzhen (CN); Hongjun LIU, Shenzhen (CN); Dongmei LI, Shenzhen (CN); Wu WEN, Shenzhen (CN); Li TIAN, Shenzhen (CN)

(21) Appl. No.: 18/388,015

(22) Filed: Nov. 8, 2023

Related U.S. Application Data
(63) Continuation of application No. PCT/CN2022/101230, filed on Jun. 24, 2022.

(51) Int. Cl. H04W 8/18; H04W 8/22

(52) U.S. Cl. CPC H04W 8/18; H04W 8/22

(57) ABSTRACT

Methods and systems for techniques for updating user equipment capability information are disclosed. In an implementation, a method of wireless communication includes receiving, by a wireless device, a capability enquiry message from a first network in a first communication connection with a first subscriber identity module of the wireless device, transmitting, by the wireless device, to the first network, a first capability information message indicating a radio access capability between the wireless device and the first network, and initiating, by the wireless device, a procedure for updating the radio access capability between the wireless device and the first network.

### CROSS-REFERENCE TO RELATED APPLICATIONS

This application is a continuation of International Patent Application No. PCT/CN2022/101230, filed on Jun. 24, 2022, the contents of which are incorporated herein by reference in their entirety.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for transferring user equipment capability information.

In one aspect, a method of data communication is disclosed. The method includes receiving, by a wireless device, a capability enquiry message from a first network in a first communication connection with a first subscriber identity module of the wireless device, transmitting, by the wireless device, to the first network, a first user equipment capability information message indicating a radio access capability between the wireless device and the first network, and initiating, by the wireless device, a procedure for updating the radio access capability between the wireless device and the first network.

In another aspect, a method of data communication is disclosed. The method includes transmitting, by a first network, a capability enquiry message to a wireless device, receiving, by the first network, a first capability information message that is transmitted from the wireless device in response to the capability enquiry message associated with a first communication connection with a first subscriber identity module of the wireless device, the first capability information message indicating a radio access capability between the wireless device and the first network, and receiving, by the first network, a second capability information message for indicating a radio access capability, wherein the second capability information message is transmitted from the wireless device without transmitting the capability enquiry message to the wireless device.

In another example aspect, a wireless communication apparatus comprising a processor configured to implement an above-described method is disclosed.

In another example aspect, a computer storage medium having code for implementing an above-described method stored thereon is disclosed.

These, and other, aspects are described in the present document.

### BRIEF DESCRIPTION OF THE DRAWING

FIG. 1 shows an example of a wireless communication system based on some example embodiments of the disclosed technology.

FIG. 2 is a block diagram representation of a portion of an apparatus based on some embodiments of the disclosed technology.

FIG. 3 shows an example of UE capability transfer based on some embodiments of the disclosed technology.

FIG. 4 shows another example of UE capability transfer based on some embodiments of the disclosed technology.

FIG. 5 shows another example of UE capability transfer based on some embodiments of the disclosed technology.

FIG. 6 shows another example of UE capability transfer based on some embodiments of the disclosed technology.

FIG. 7 shows an example of UE capability transfer procedure of a wireless device based on some embodiments of the disclosed technology.

FIG. 8 shows an example of UE capability transfer procedure of a network based on some embodiments of the disclosed technology.

FIG. 9 shows an example of a process for wireless communication based on some example embodiments of the disclosed technology.

FIG. 10 shows another example of a process for wireless communication based on some example embodiments of the disclosed technology.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

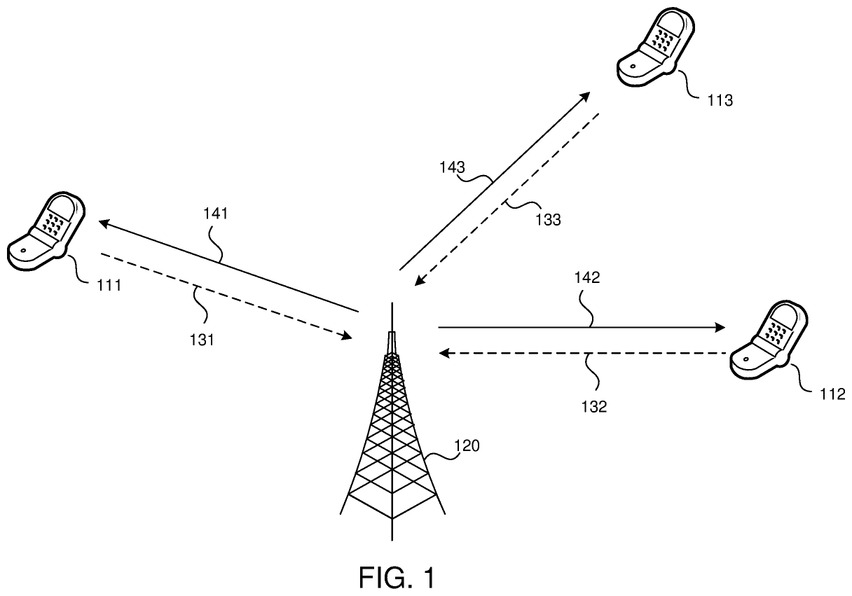

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

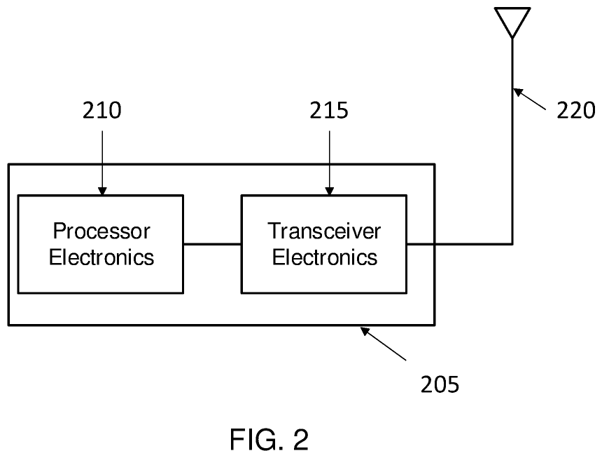

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

The hardware capabilities of UE include multiple universal subscriber identity modules (MUSIM) that are shared by a plurality of SIMs. In order to use the hardware capabilities of UE efficiently and economically, the hardware capabilities need to be dynamically split between the multiple SIMs. In some cases, UE can experience a temporary hardware conflict, which may require UE to release some resources (e.g., SCell/SCG) from one of the SIMs. For example, when SIM A of a UE is in a Radio Resource Control (RRC) connected state in Network A while SIM B of the UE is in an RRC idle state or RRC inactive state in Network B, the two radio frequency (RF) chains will be occupied by the SIM A for the communication in Network A. Once the UE's SIM B enters an RRC connected state, one of the RF chains needs to be switched to SIM B. In this case, if Network A is not aware of the UE's reduced capability in RF chain, there may be data loss due to demodulation failures and wasting radio resources in Network A. The disclosed technology can be implemented in some embodiments to address these issues by imposing temporary restrictions on the UE capability using assistance (e.g., assistance information) from the UE in communication with Network A.

In some implementations, dual transmitter/receiver (Tx/Rx) MUSIM can be used. For example, the following techniques can be employed to implement MUSIM.

UE Capability

In some implementations, two capability bits are introduced, one for support gaps and another for “leaving connected.” There is no need for different capability bits for periodic and aperiodic gaps.

The MUSIM related capability is per UE (without FRx and xDD differentiation).

In some implementations, the following techniques can be employed.

UE Notification on Network Switching for Multi-SIM

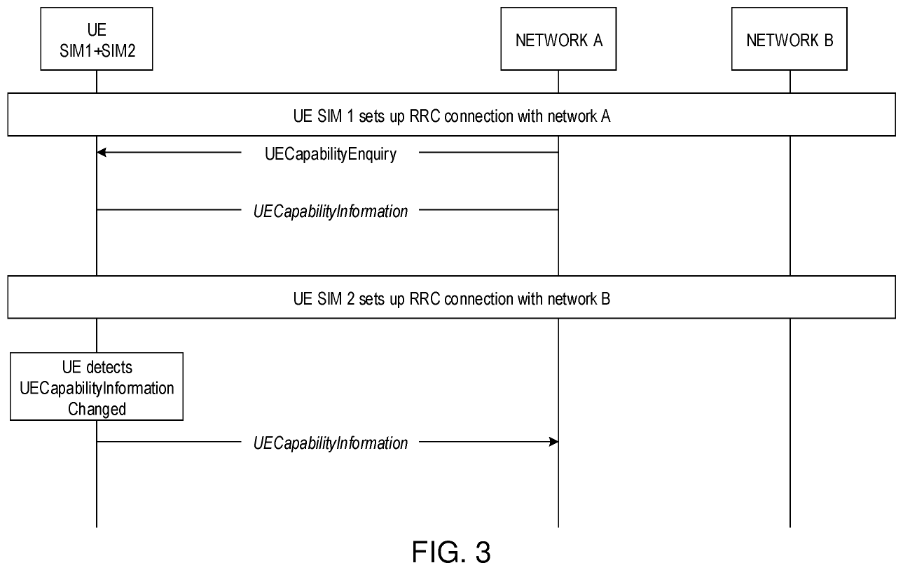

FIG. 3 shows an example of UE capability transfer based on some embodiments of the disclosed technology.

In some embodiments of the disclosed technology, UE capability transfer may include the following operations:
1. UE has 2 USIMs (Sim1 and Sim2), and UE sets up RRC connection with network A using SIM1;
2. Network A sends a UE capability enquiry message (UECapabilityEnquiry message) to UE to retrieve UE radio access capability information;
3. UE sends a first UE capability information message (UEcapabilityinformation message 1) to network A in response to the UE capability enquiry message (UECapabilityEnquiry message) and submits the UE capability information to the network;
4. UE initiates RRC connection set up procedure with network B using SIM2 (e.g., sends RRCsetuprequest message);
5. UE detects UE capability information, which UE can provide to network A, has been changed because of RRC connection with network B. The connection with network B occupies one or more TXs/RXs, resulting in changes in the UE radio access capability, which UE can provide to network A; and
6. UE sends a second UE capability information message (UEcapabilityinformation message 2) to network A to update the UE capability information.

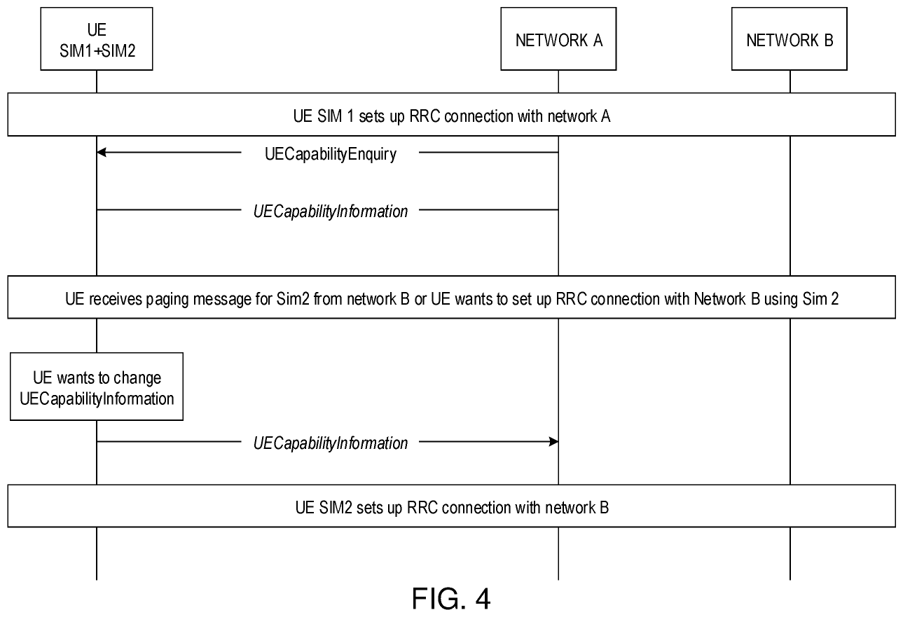

FIG. 4 shows another example of UE capability transfer based on some embodiments of the disclosed technology.

In some embodiments of the disclosed technology, UE capability transfer may include the following operations:
1. UE has 2 USIMs (Sim1 and Sim2), and UE sets up RRC connection with network A using SIM1;
2. Network A sends a UE capability enquiry message (UECapabilityEnquiry message) to UE to retrieve UE radio access capability information;
3. UE sends a first UE capability information message (UEcapabilityinformation message 1) to network A in response to the UE capability enquiry message (UECapabilityEnquiry message) and submits the UE capability information to the network;
4. UE receives paging message for Sim2 from network B or UE wants to set up RRC connection with network B using SIM 2;
5. In order to set up RRC connection with network B, UE will use or transfer at least one TX/RX for network B. Thus, UE will try to change or update the UE capabilities provided to network A;
6. UE sends a second UE capability information message (UEcapabilityinformation message 2) to network A to update the UE capability information; and
7. UE initiates RRC connection set up procedure with network B using SIM2 after, before, or at the same time as the above step 6.

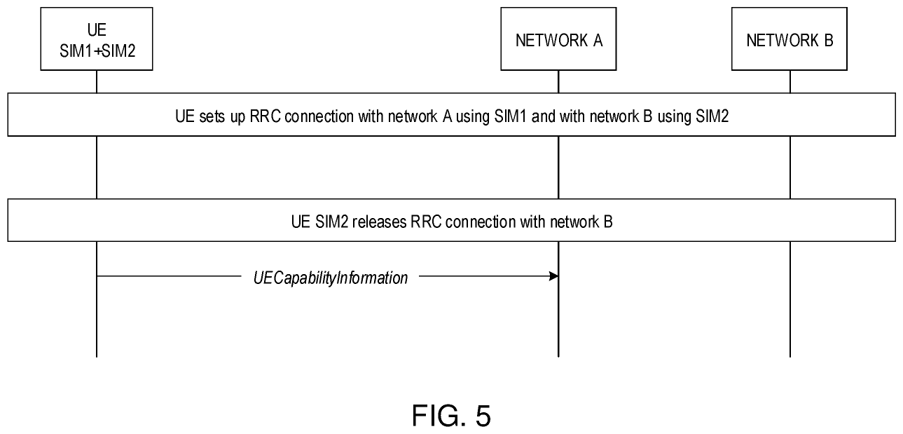

FIG. 5 shows another example of UE capability transfer based on some embodiments of the disclosed technology.

In some embodiments of the disclosed technology, UE capability transfer may include the following operations:
1. UE has set up RRC connection with network A using SIM1 and with network B using SIM2. During the procedure, UE may have sent a UE capability information message (UEcapabilityinformation message) to network A and/or network B following the procedure shown in FIG. 3 or FIG. 4;
2. UE releases RRC connection with network B, and the related TX/RX resource will be released; and
3. UE detects the UE capabilities, which UE can provide to network A, has been changed. The UE sends another a UE capability information message (UEcapabilityinformation message 2) to network A to update UE capability information.

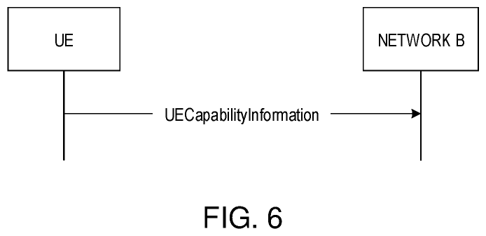

FIG. 6 shows another example of UE capability transfer based on some embodiments of the disclosed technology.

Different from the current technology, a new scenario can be added to UE capability transfer. The UE can initiate the UE capability information update procedure for the network.

Table 1: UE capability information message (UECapabilityInformation message)

-- ASN1START
-- TAG-UECAPABILITYINFORMATION-START

| | |
|---|---|
| UECapabilityInformation ::= | SEQUENCE { |
| rrc-TransactionIdentifier | RRC-TransactionIdentifier, |
| criticalExtensions | CHOICE { |
| ueCapabilityInformation | UECapabilityInformation-IEs, |
| criticalExtensionsFuture | SEQUENCE { } |

}
}

| | |
|---|---|
| UECapabilityInformation-IEs ::= | SEQUENCE { |
| ue-CapabilityRAT-ContainerList | UE-CapabilityRAT-ContainerList |

OPTIONAL,

| | |
|---|---|
| lateNonCriticalExtension | OCTET STRING |

OPTIONAL,

| | |
|---|---|
| nonCriticalExtension | SEQUENCE{ } |

OPTIONAL
}
-- TAG-UECAPABILITYINFORMATION-STOP
-- ASN1STOP

| | |
|---|---|
| UE-CapabilityRAT-ContainerList ::= | SEQUENCE (SIZE (0..maxRAT-CapabilityContainers)) OF UE- |

CapabilityRAT-Container

| | |
|---|---|
| UE-CapabilityRAT-Container ::= | SEQUENCE { |
| rat-Type | RAT-Type, |
| ue-CapabilityRAT-Container | OCTET STRING |
| ue-CapabilityRAT-Container_2 | OCTET STRING |

}
-- TAG-UE-CAPABILITYRAT-CONTAINERLIST-STOP
-- ASN1STOP

| | |
|---|---|
| UE-NR-Capability ::= | SEQUENCE { |

| | |
|---|---|
| accessStratumRelease | AccessStratumRelease, |
| pdcp-Parameters | PDCP-Parameters, |
| rlc-Parameters | RLC-Parameters |

OPTIONAL,

| | |
|---|---|
| mac-Parameters | MAC-Parameters |

OPTIONAL,

| | |
|---|---|
| phy-Parameters | Phy-Parameters, |
| rf-Parameters | RF-Parameters, |
| measAndMobParameters | MeasAndMobParameters |

OPTIONAL,

| | |
|---|---|
| fdd-Add-UE-NR-Capabilities | UE-NR-CapabilityAddXDD-Mode |

OPTIONAL,

| | |
|---|---|
| tdd-Add-UE-NR-Capabilities | UE-NR-CapabilityAddXDD-Mode |

OPTIONAL,

| | |
|---|---|
| fr1-Add-UE-NR-Capabilities | UE-NR-CapabilityAddFRX-Mode |

OPTIONAL,

| | |
|---|---|
| fr2-Add-UE-NR-Capabilities | UE-NR-CapabilityAddFRX-Mode |

OPTIONAL,

| | |
|---|---|
| featureSets | FeatureSets |

OPTIONAL,

| | |
|---|---|
| featureSetCombinations | SEQUENCE (SIZE (1..maxFeatureSetCombinations)) OF |

| | |
|---|---|
| FeatureSetCombination | OPTIONAL, |

| | |
|---|---|
| lateNonCriticalExtension | OCTET STRING (CONTAINING UE-NR-Capability-v15c0) |

OPTIONAL,

| | |
|---|---|
| nonCriticalExtension | UE-NR-Capability-v1530 |

OPTIONAL
}

The first and second UE capability information messages (UEcapabilityInformation messages 1 and 2) can include the contents of UE capability information message under the current technology.

In some implementations, in the first UE capability information message (UEcapabilityInformation message 1), a ue-CapabilityRAT-Container_2 is introduced.

In some implementations, the capability sets in ue-CapabilityRAT-Container_2 and ue-CapabilityRAT-Container are different.

In some implementations, the network may store the UE capabilities in the two containers, and may take one of them as UE's capability.

In the second UE capability information message (UEcapabilityInformation message 2), one or more indicators can be included to indicate which of the containers includes the contents in accordance with the current UE capabilities.

The indicator may indicate the UE capabilities of one Radio Access Technology (RAT) type, or may indicate the UE capabilities of all RAT-types in the first UE capability information message (UEcapabilityInformation message1).

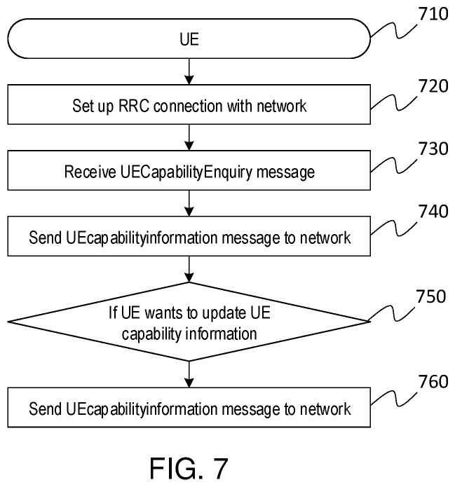

FIG. 7 shows an example of UE capability transfer procedure of a wireless device based on some embodiments of the disclosed technology.

In some embodiments of the disclosed technology, UE capability transfer may include the following operations:
1. UE sets up RRC connection with a network;
2. UE receives UE capability enquiry message (UEcapabilityEnquiry message) from the network;
3. UE sends a first UE capability information message (UEcapabilityInformation message 1) to the network in response to the UE capability enquiry message (UEcapabilityEnquiry message);
4. After 740, while UE maintains the RRC connection with the network, if the UE wants to update the UE capability information, because SIM2 sets up a new RRC connection with another network (multi-sim UE), or UE releases RRC connection with another network using SIM2 (multi-sim UE), or any other reasons; and
5. The UE send a second UE capability information message (UEcapabilityInformation message 2) to the network to update UE capability information.

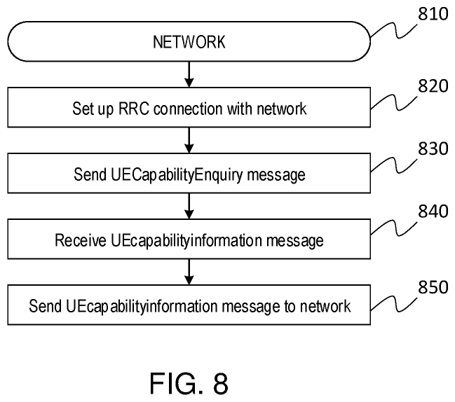

FIG. 8 shows an example of UE capability transfer procedure of a network based on some embodiments of the disclosed technology.

In some embodiments of the disclosed technology, UE capability transfer may include the following operations:
1. A network sets up RRC connection with a UE;
2. The network sends UE capability enquiry message (UEcapabilityEnquiry message) to the UE;
3. The network receives a first UE capability information message (UEcapabilityInformation message 1), which is sent in response to the UE capability enquiry message (UEcapabilityEnquiry message); and
4. The network receives a second UE capability information message (UEcapabilityInformation message 2) initiated by the UE, and updates the UE's capability information stored in the network.

In some implementations, UE capability information messages 1 and 2 may use the same format as the UE capability information message under the current technology.

In the above step 3, the network may receive the first UE capability information message (UE capabilityInformation message 1), and may configure/re-configure/setup/release the RRC connection with the UE based on the UE's capability in the first UE capability information message (UE capabilityinformation message 1).

In the above step 4, the network may receive a second UE capability information message 2 (UEcapabilityInformation message 2), and may update UE capabilities based on the contents in the second UE capability information message 2 (UEcapabilityInformation message 2), and may configure/re-configure/setup/release the RRC connection with the UE based on the UE's capability.

In some implementations, the first UE capability information message (UE capabilityInformation message 1) includes a plurality of capability sets and message2 with one or more indicators.

In the above step 3, the network may receive the first UE capability information message (UE capabilityInformation message 1) (with a plurality of capability sets for one RAT), and may configure/re-configure/setup/release the RRC connection with the UE based on one of the plurality of capability sets in the first UE capability information message (UE capabilityInformation message 1).

In the above step 4, the network may receive the second UE capability information message 2 (UEcapabilityInformation message 2), and may update UE capabilities based on the indicator in the second UE capability information message 2 (UEcapabilityInformation message 2) and the sets in the first UE capability information message (UE capabilityInformation message 1), and may configure/re-configure/setup/release the RRC connection with the UE based on the UE's capability.

As discussed above, if a network is not aware of changes in the radio access capability of a wireless device in communication with the network, radio resources can be wasted, and data loss can occur. The disclosed technology can be implemented in some embodiments to address these issues by updating UE capability information using the second UE capability information message, which is different from the first UE capability information message transmitted in response to the UE capability enquiry message.

In some implementations, the UE initiates the capability transfer procedure for the network to update the UE capability information.

In some implementations, the capability information is changed by RRC connection set up procedure with network B using SIM2.

In some implementations, the changes in the UE capability information cause the UE to initiate the capability transfer procedure.

In some implementations, the UE, who wants to change the UE capability information for another connection with network B using another SIM, can initiate the capability transfer procedure.

In some implementations, the UE capability transfer procedure may include the following operations: 1) UE has 2 USIMs (Sim1 and Sim2), and UE sets up RRC connection with network A using SIM1; 2) The network A sends UE capability enquiry message to UE to retrieve UE radio access capability information; 3) The UE sends UE capability information message 1 to the network A in response to the enquiry message and submits the UE capability information to the network; 4) The UE initiates RRC connection set up procedure with network B using SIM2 (e.g., sends RRC setup request message); 5) The UE detects UE capability information, which the UE can provide to network A, has been changed because of RRC connection with network B. The connection with network B occupies one or more TXs/RXs, resulting in changes in the UE radio access capability, which the UE can provide to network A; and 6) The UE sends UE capability information message 2 to the network A to update the UE capability information.

In some implementations, the UE capability transfer procedure may use new formats for the first and second UE capability information messages (UEcapabilityinformation messages 1 and 2).

In some implementations, the first UE capability information message (UEcapabilityinformation message1) may include a plurality of UE capability sets for one rat-type. In addition, one or more indicators in the second UE capability information message 2 (UEcapabilityInformation message 2) can be used to indicate which set should be used.

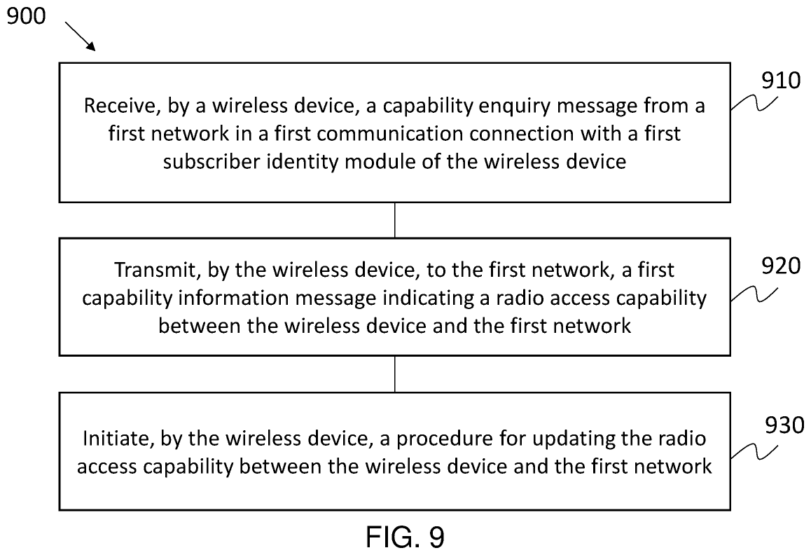

FIG. 9 shows an example of a process for wireless communication based on some example embodiments of the disclosed technology.

In some implementations, the process 900 for wireless communication may include, at 910, receiving, by a wireless device, a capability enquiry message from a first network in a first communication connection with a first subscriber identity module of the wireless device, at 920, transmitting, by the wireless device, to the first network, a first user equipment capability information message indicating a radio access capability between the wireless device and the first network, and at 930, initiating, by the wireless device, a procedure for updating the radio access capability between the wireless device and the first network.

In some implementations, the process 900 may further comprise updating the radio access capability between the wireless device and the first network by transmitting, by the wireless device, to the first network, a second user equipment capability information message to indicate a radio access capability between the wireless device and the first network.

In some implementations, the first user equipment capability information message may include the first UE capability information message (UEcapabilityinformation message 1) discussed above. In some implementations, the second user equipment capability information message may include the second UE capability information message (UEcapabilityinformation message 2) discussed above.

In some implementations, the first network may include a base station including a next generation Node B (gNB), enhanced Node B (eNB), or any other device that performs as a base station. In some implementations, the wireless device may include user equipment (UE).

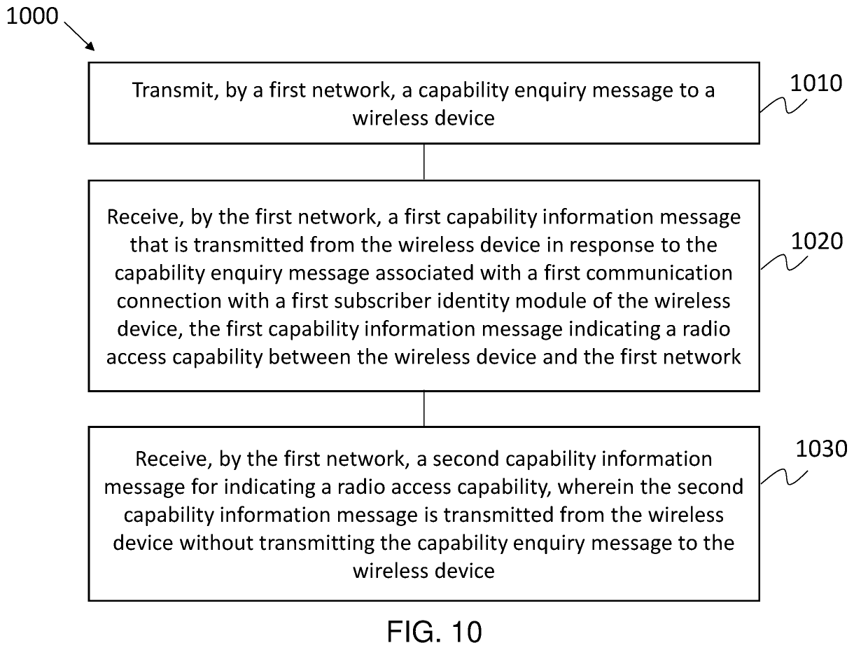

FIG. 10 shows another example of a process for wireless communication based on some example embodiments of the disclosed technology.

In some implementations, the process 1000 for wireless communication may include, at 1010, transmitting, by a first network, a capability enquiry message to a wireless device, at 1020, receiving, by the first network, a first capability information message that is transmitted from the wireless device in response to the capability enquiry message associated with a first communication connection with a first subscriber identity module of the wireless device, the first capability information message indicating a radio access capability between the wireless device and the first network, and at 1030, receiving, by the first network, a second capability information message for indicating a radio access capability, wherein the second capability information message is transmitted from the wireless device without transmitting the capability enquiry message to the wireless device.

In some implementations, the first user equipment capability information message may include the first UE capability information message (UEcapabilityinformation message 1) discussed above. In some implementations, the second user equipment capability information message may include the second UE capability information message (UEcapabilityinformation message 2) discussed above.

In some implementations, the first network may include a base station including a next generation Node B (gNB), enhanced Node B (eNB), or any other device that performs as a base station. In some implementations, the wireless device may include user equipment (UE).

In some implementations, the wireless device includes a plurality of SIMs. For example, the plurality of SIMs includes the first subscriber identity module (e.g., SIM1) and the second first subscriber identity module (e.g., SIM2), and the SIM1 is used to communicate with the first network, and the SIM2 is used to communicate with the second network.

It will be appreciated that the present document discloses techniques that can be embodied in various embodiments to determine downlink control information in wireless networks. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some embodiments may preferably implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station.

Clause 1. A method of wireless communication, comprising: receiving, by a wireless device, a capability enquiry message from a first network in a first communication connection with a first subscriber identity module of the wireless device; transmitting, by the wireless device, to the first network, a first user equipment capability information message indicating a radio access capability between the wireless device and the first network; and initiating, by the wireless device, a procedure for updating the radio access capability between the wireless device and the first network.

In some implementations, the first user equipment capability information message may include the first UE capability information message (UEcapabilityinformation message 1) discussed above.

In some implementations, the first network may include a base station including a next generation Node B (gNB), enhanced Node B (eNB), or any other device that performs as a base station. In some implementations, the wireless device may include user equipment (UE).

Clause 2. The method of clause 1, further comprising updating the radio access capability between the wireless device and the first network by transmitting, by the wireless device, to the first network, a second user equipment capability information message to indicate a radio access capability between the wireless device and the first network.

In some implementations, the second user equipment capability information message may include the second UE capability information message (UEcapabilityinformation message 2) discussed above.

Clause 3. The method of clause 2, wherein the first user equipment capability information message is transmitted upon receiving the capability enquiry message, and the second user equipment capability information message is transmitted without receiving the capability enquiry message.

Clause 4. The method of clause 1, further comprising updating the radio access capability between the wireless device and the first network based on an establishment or a release of a second communication connection or based on a determination by the wireless device to update the radio access capability between the wireless device and the first network.

Clause 5. The method of clause 4, wherein the second communication connection is a communication with the second network using a second subscriber identity module of the wireless device.

Clause 6. The method of clause 2, wherein the first user equipment capability information message includes at least two user equipment radio access capability sets associated with the wireless device, and wherein the second user equipment capability information message includes a capability information indicator to indicate a user equipment radio access capability set of the two user equipment radio access capability sets.

Clause 7. The method of clause 6, wherein the user equipment capability sets are combined with one or more user equipment capability radio access technology (RAT) containers, wherein each user equipment capability RAT container indicates user equipment capabilities associated with one RAT type.

Clause 8. The method of clause 6, wherein the capability information indicator in the second user equipment capability information message indicates a user equipment capability set in the user equipment capability information message combined with one or more user equipment capability RAT containers in the first user equipment capability information message.

Clause 9. The method of clause 6, wherein the capability information indicator indicates which one of the user equipment radio access capability sets is to be used.

Clause 10. The method of any of clauses 1-9, wherein the first communication connection and the second communication connection include a radio resource control (RRC) connection.

Clause 11. A method of wireless communication, comprising: transmitting, by a first network, a capability enquiry message to a wireless device; receiving, by the first network, a first capability information message that is transmitted from the wireless device in response to the capability enquiry message associated with a first communication connection with a first subscriber identity module of the wireless device, the first capability information message indicating a radio access capability between the wireless device and the first network; and receiving, by the first network, a second capability information message for indicating a radio access capability, wherein the second capability information message is transmitted from the wireless device without transmitting the capability enquiry message to the wireless device.

In some implementations, the first user equipment capability information message may include the first UE capability information message (UEcapabilityinformation message 1) discussed above. In some implementations, the second user equipment capability information message may include the second UE capability information message (UEcapabilityinformation message 2) discussed above.

In some implementations, the first network may include a base station including a next generation Node B (gNB), enhanced Node B (eNB), or any other device that performs as a base station. In some implementations, the wireless device may include user equipment (UE).

Clause 12. The method of clause 11, further comprising updating, by the first network, the radio access capability between the wireless device and the first network based on the second capability information message, wherein the updating of the radio access capability between the wireless device and the first network is performed upon establishing a second communication connection between the wireless device and a second network or upon releasing the second communication connection.

Clause 13. The method of clause 11, wherein the second capability information message includes a capability information indicator for indicating an update to the radio access capability associated with the wireless device.

Clause 14. The method of clause 11, wherein the first capability information message includes a plurality of capability information sets for each radio access technology (RAT) type.

Clause 15. The method of clause 11, wherein the second capability information message includes a capability information indicator for indicating an update to the radio access capability associated with the wireless device, and the first capability information message includes a plurality of capability information sets, and wherein the updating of the radio access capability between the wireless device and the first network is performed based on the capability information indicator in the second capability information message and the plurality of capability information sets in the first capability information message.

Clause 16. The method of clause 15, wherein each of the capability information sets is combined with one or more user equipment capability RAT containers, wherein each user equipment capability RAT container indicates user equipment capabilities associated with one RAT type.

Clause 17. An apparatus for wireless communication comprising a processor that is configured to carry out the method of any of clauses 1 to 16.

Clause 18. A non-transitory computer readable medium having code stored thereon, the code when executed by a processor, causing the processor to implement a method recited in any of clauses 1 to 16.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
receiving, by a wireless device, a capability enquiry message from a first network in a first communication connection with a first subscriber identity module of the wireless device;
transmitting, by the wireless device, to the first network, a first user equipment capability information message indicating a radio access capability between the wireless device and the first network; and
initiating, by the wireless device, a procedure for updating the radio access capability between the wireless device and the first network.

2. The method of claim 1, further comprising updating the radio access capability between the wireless device and the first network by transmitting, by the wireless device, to the first network, a second user equipment capability information message to indicate a radio access capability between the wireless device and the first network.

3. The method of claim 2, wherein the first user equipment capability information message is transmitted upon receiving the capability enquiry message, and the second user equipment capability information message is transmitted without receiving the capability enquiry message.

4. The method of claim 1, further comprising updating the radio access capability between the wireless device and the first network based on an establishment or a release of a second communication connection or based on a determination by the wireless device to update the radio access capability between the wireless device and the first network.

5. The method of claim 4, wherein the second communication connection is a communication with the second network using a second subscriber identity module of the wireless device.

6. The method of claim 2, wherein the first user equipment capability information message includes at least two user equipment radio access capability sets associated with the wireless device, and wherein the second user equipment capability information message includes a capability information indicator to indicate a user equipment radio access capability set of the two user equipment radio access capability sets.

7. The method of claim 6, wherein the user equipment capability sets are combined with one or more user equipment capability radio access technology (RAT) containers, wherein each user equipment capability RAT container indicates user equipment capabilities associated with one RAT type.

8. The method of claim 6, wherein the capability information indicator in the second user equipment capability information message indicates a user equipment capability set in the user equipment capability information message combined with one or more user equipment capability RAT containers in the first user equipment capability information message.

9. The method of claim 6, wherein the capability information indicator indicates which one of the user equipment radio access capability sets is to be used.

10. The method of claim 4, wherein the first communication connection and the second communication connection include a radio resource control (RRC) connection.

11. A method of wireless communication, comprising:
transmitting, by a first network, a capability enquiry message to a wireless device;
receiving, by the first network, a first capability information message that is transmitted from the wireless device in response to the capability enquiry message associated with a first communication connection with a first subscriber identity module of the wireless device, the first capability information message indicating a radio access capability between the wireless device and the first network; and
receiving, by the first network, a second capability information message for indicating a radio access capability, wherein the second capability information message is transmitted from the wireless device without transmitting the capability enquiry message to the wireless device.

12. The method of claim 11, further comprising updating, by the first network, the radio access capability between the wireless device and the first network based on the second capability information message, wherein the updating of the radio access capability between the wireless device and the first network is performed upon establishing a second communication connection between the wireless device and a second network or upon releasing the second communication connection.

13. The method of claim 11, wherein the second capability information message includes a capability information indicator for indicating an update to the radio access capability associated with the wireless device.

14. The method of claim 11, wherein the first capability information message includes a plurality of capability information sets for each radio access technology (RAT) type.

15. The method of claim 11, wherein the second capability information message includes a capability information indicator for indicating an update to the radio access capability associated with the wireless device, and the first capability information message includes a plurality of capability information sets, and wherein the updating of the radio access capability between the wireless device and the first network is performed based on the capability information indicator in the second capability information message and the plurality of capability information sets in the first capability information message.

16. The method of claim 15, wherein each of the capability information sets is combined with one or more user equipment capability RAT containers, wherein each user equipment capability RAT container indicates user equipment capabilities associated with one RAT type.

17. An apparatus for wireless communication comprising a processor that is configured to carry out a method comprising:
receiving, by a wireless device, a capability enquiry message from a first network in a first communication connection with a first subscriber identity module of the wireless device;
transmitting, by the wireless device, to the first network, a first user equipment capability information message indicating a radio access capability between the wireless device and the first network; and
initiating, by the wireless device, a procedure for updating the radio access capability between the wireless device and the first network.

18. The apparatus of claim 17, wherein the method further comprises:
updating the radio access capability between the wireless device and the first network by transmitting, by the wireless device, to the first network, a second user equipment capability information message to indicate a radio access capability between the wireless device and the first network.

19. The apparatus of claim 17, wherein the method further comprises:
updating the radio access capability between the wireless device and the first network based on an establishment or a release of a second communication connection or based on a determination by the wireless device to update the radio access capability between the wireless device and the first network.

20. The apparatus of claim 19, wherein the first communication connection and the second communication connection include a radio resource control (RRC) connection.
